(19) United States
(12) Patent Application Publication
(10) Pub. No.: US 2024/0005032 A1
(43) Pub. Date: Jan. 4, 2024

(54) DISCOVERING, ASSESSING, AND REMEDIATING CLOUD NATIVE APPLICATION RISKS DUE TO SECURITY MISCONFIGURATIONS

(71) Applicant: Accenture Global Solutions Limited, Dublin (IE)

(72) Inventors: Kanchanjot Kaur PHOKELA, New Delhi (IN); Kapil SINGI, Bangalore (IN); Kuntal DEY, Birbhum (IN); Vikrant KAULGUD, Pune (IN); Adam Patten BURDEN, Tampa, FL (US)

(21) Appl. No.: 18/343,408

(22) Filed: Jun. 28, 2023

(30) Foreign Application Priority Data
Jun. 30, 2022 (IN) 202241037665

(51) Int. Cl. G06F 21/62; G06F 21/57

(52) U.S. Cl. CPC G06F 21/6245; G06F 2221/034; G06F 21/577

(57) ABSTRACT

A device may generate a knowledge model based on a knowledge model schema, data residency constraints, and a data classification ontology associated with a cloud application, and may perform a dynamic flow analysis of the cloud application data and the data source identifiers to generate a data flow graph. The device may process the data flow graph, with the knowledge model, to determine sensitive attributes in the data flow graph, and may identify sensitive data sources that include the sensitive attributes and sensitive assets based on the data flow graph and the sensitive data sources. The device may process the sensitive data sources and the sensitive assets, with a machine learning model, to determine methods for identifying misconfigurations, and may utilize the methods to identify misconfigurations and severities of the misconfigurations. The device may generate remediation actions for correcting the cloud application based on the severities of the misconfigurations.

### CROSS-REFERENCE TO RELATED APPLICATION

This Patent Application claims priority to Indian Patent Application No. 202241037665, filed on Jun. 30, 3022, and entitled DISCOVERING, ASSESSING, AND REMEDIATING CLOUD NATIVE APPLICATION RISKS DUE TO SECURITY MISCONFIGURATIONS.” The disclosure of the prior Application is considered part of and is incorporated by reference into this Patent Application.

### BACKGROUND

Cloud computing environments (e.g., infrastructure) and applications provided by such environments may be deployed across borders, which may pose security risks to application users' personal data.

### SUMMARY

Some implementations described herein relate to a method. The method may include receiving cloud application data associated with a cloud application, data source identifiers, knowledge model schema, data residency constraints, and a data classification ontology, and generating a knowledge model based on the knowledge model schema, the data residency constraints, and the data classification ontology. The method may include performing a dynamic flow analysis of the cloud application data and the data source identifiers to generate a data flow graph that depicts a flow of data to services from the data source, and processing the data flow graph, with the knowledge model, to determine sensitive attributes in the data flow graph. The method may include identifying one or more sensitive data sources that include the sensitive attributes, and identifying sensitive assets based on the data flow graph and the one or more sensitive data sources. The method may include processing the one or more sensitive data sources and the sensitive assets, with a machine learning model, to determine methods for identifying misconfigurations in the sensitive data sources and the sensitive assets, and utilizing the methods to identify misconfigurations in the one or more sensitive data sources and the sensitive assets and severities of the misconfigurations. The method may include generating remediation actions to correct the misconfigurations based on the severities of the misconfigurations, and modifying the cloud application based on the remediation actions to generate a compliant cloud application.

Some implementations described herein relate to a device. The device may include one or more memories and one or more processors coupled to the one or more memories. The one or more processors may be configured to receive cloud application data associated with a cloud application, data source identifiers, knowledge model schema, data residency constraints, and a data classification ontology, and generate a knowledge model based on the knowledge model schema, the data residency constraints, and the data classification ontology. The one or more processors may be configured to perform a dynamic flow analysis of the cloud application data and the data source identifiers to generate a data flow graph that depicts a flow of data to services from the data source, and process the data flow graph, with the knowledge model, to determine sensitive attributes in the data flow graph. The one or more processors may be configured to identify one or more sensitive data sources that include the sensitive attributes, and identify sensitive assets based on the data flow graph and the one or more sensitive data sources. The one or more processors may be configured to process the one or more sensitive data sources and the sensitive assets, with a machine learning model, to determine methods for identifying misconfigurations in the sensitive data sources and the sensitive assets, and utilize the methods to identify misconfigurations in the one or more sensitive data sources and the sensitive assets and severities of the misconfigurations. The one or more processors may be configured to generate remediation actions to correct the misconfigurations based on the severities of the misconfigurations, and modify the cloud application based on the remediation actions to generate a compliant cloud application. The one or more processors may be configured to cause the compliant cloud application to be deployed in a cloud computing environment.

Some implementations described herein relate to a non-transitory computer-readable medium that stores a set of instructions. The set of instructions, when executed by one or more processors of a device, may cause the device to receive cloud application data associated with a cloud application, data source identifiers, knowledge model schema, data residency constraints, and a data classification ontology, wherein the cloud application data includes data identifying an architecture flow of the cloud application, a process flow of the cloud application, and a control flow of the cloud application. The set of instructions, when executed by one or more processors of the device, may cause the device to generate a knowledge model based on the knowledge model schema, the data residency constraints, and the data classification ontology, and perform a dynamic flow analysis of the cloud application data and the data source identifiers to generate a data flow graph that depicts a flow of data to services from the data source. The set of instructions, when executed by one or more processors of the device, may cause the device to process the data flow graph, with the knowledge model, to determine sensitive attributes in the data flow graph, and identify one or more sensitive data sources that include the sensitive attributes. The set of instructions, when executed by one or more processors of the device, may cause the device to identify sensitive assets based on the data flow graph and the one or more sensitive data sources, and process the one or more sensitive data sources and the sensitive assets, with a machine learning model, to determine methods for identifying misconfigurations in the sensitive data sources and the sensitive assets. The set of instructions, when executed by one or more processors of the device, may cause the device to utilize the methods to identify misconfigurations in the one or more sensitive data sources and the sensitive assets and severities of the misconfigurations, and generate remediation actions to correct the misconfigurations based on the severities of the misconfigurations. The set of instructions, when executed by one or more processors of the device, may cause the device to modify the cloud application based on the remediation actions to generate a compliant cloud application.

### BRIEF DESCRIPTION OF THE DRAWINGS

FIGS. 1A-1H are diagrams of an example implementation associated with discovering, assessing, and remediating cloud native application risks due to security misconfigurations.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for discovering, assessing, and remediating cloud native application risks due to security misconfigurations.

### DETAILED DESCRIPTION

The following detailed description of example implementations refers to the accompanying drawings. The same reference numbers in different drawings may identify the same or similar elements.

Non-compliance with protecting application users' personal data may lead to monetary penalties, loss of reputation, and erosion of trust for cloud service providers. Cloud service providers attempt to provide compliance as a service (CaaS) for users' personal data, but infrastructure security misconfigurations and unaddressed security violations may cause a cloud computing environment to be non-compliant. Security misconfigurations remain a primary concern for cloud service providers.

In an era of third-party libraries and ready to market architecture solutions, developers generally prefer predefined or default configurations before deploying applications with cloud service providers. These predefined configurations are set by default to cater to security and privacy norms, but may not focus on data-security-based specifications. Regulations and constraints governing data and data usage have started to be implemented. For example, data sovereignty laws have been implemented that pertain to country-specific regulations on the use and collection of data. Cloud technologies and applications provide a basis for access to globally-distributed data centers, which potentially help in efficient, cost-effective, and scalable solutions. Regulations governing data may potentially impact ways in which cloud applications are created. Current security practices tend to focus on business service level agreements (SLAs), privacy enforcing regulations, security standards, and/or the like. However, current security practices may fail to facilitate development of compliant cloud native applications.

Therefore, current techniques for providing compliant cloud native applications consume computing resources (e.g., processing resources, memory resources, communication resources, and/or the like), networking resources, and/or the like associated with failing to facilitate development of compliant cloud native applications, spending time and money and other resources on developing cloud native applications with infrastructure security misconfigurations and unaddressed security violations, handling security violations caused by cloud native applications with infrastructure security misconfigurations and unaddressed security violations, and/or the like.

Some implementations described herein relate to a security system that discovers, assesses, and remediates cloud native application risks due to security misconfigurations. For example, the security system may receive cloud application data associated with a cloud application, data source identifiers, knowledge model schema, data residency constraints, and a data classification ontology, and may generate a knowledge model based on the knowledge model schema, the data residency constraints, and the data classification ontology. The security system may perform a dynamic flow analysis of the cloud application data and the data source identifiers to generate a data flow graph that depicts a flow of data to services from the data source, and may process the data flow graph, with the knowledge model, to determine sensitive attributes in the data flow graph. The security system may identify one or more sensitive data sources that include the sensitive attributes, and may identify sensitive assets based on the data flow graph and the one or more sensitive data sources. The security system may process the one or more sensitive data sources and the sensitive assets, with a machine learning model, to determine methods for identifying misconfigurations in the sensitive data sources and the sensitive assets, and may utilize the methods to identify misconfigurations in the one or more sensitive data sources and the sensitive assets and severities of the misconfigurations. The security system may generate remediation actions to correct the misconfigurations based on the severities of the misconfigurations, and may modify the cloud application based on the remediation actions to generate a compliant cloud application. The security system may cause the compliant cloud application to be deployed in a cloud computing environment.

In this way, the security system discovers, assesses, and remediates cloud native application risks due to security misconfigurations. The security system may secure configuration files (e.g., of a cloud native application) for security vulnerabilities, compliance issues, and infrastructure misconfigurations, and may label artifacts with sensitive information in a microservice application architecture for pre-deployment compliance assessment and automatic remediation for noncompliance. The security system may generate target deployment configurations (e.g., for the cloud native application) that are compliant and secure in terms of data sensitivity, client inputs, and applicable constraints. This, in turn, conserves computing resources, networking resources, and/or the like that would otherwise have been consumed in failing to accurately assess whether the application can be viably migrated to a cloud computing environment, spending time and money and other resources on migration of a non-functional application to the cloud computing environment, attempting and failing to migrate the application to the cloud computing environment, and/or the like.

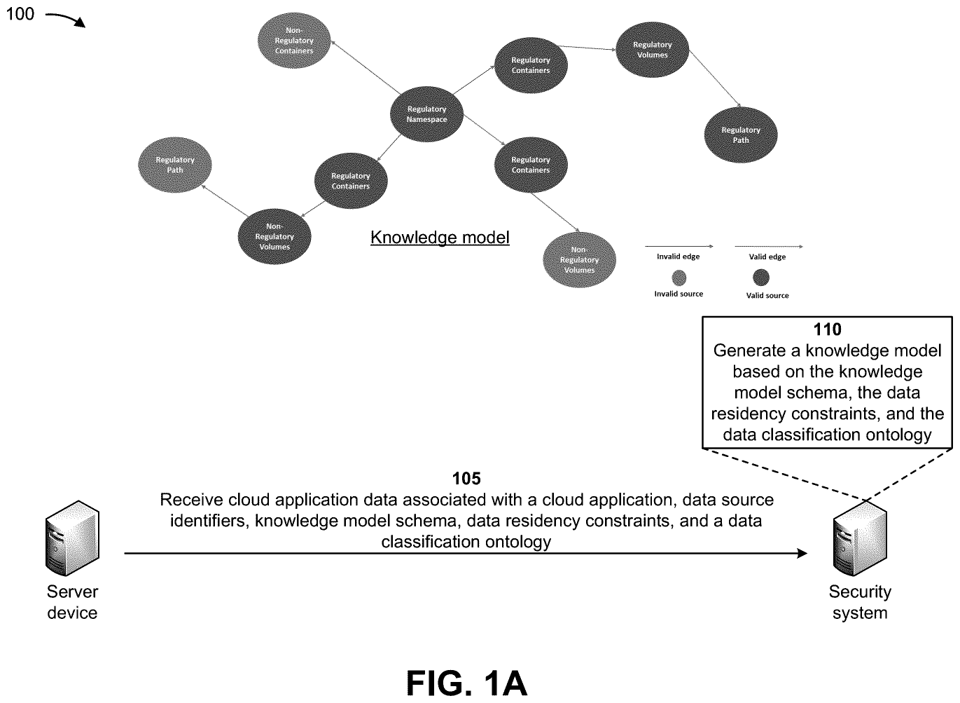

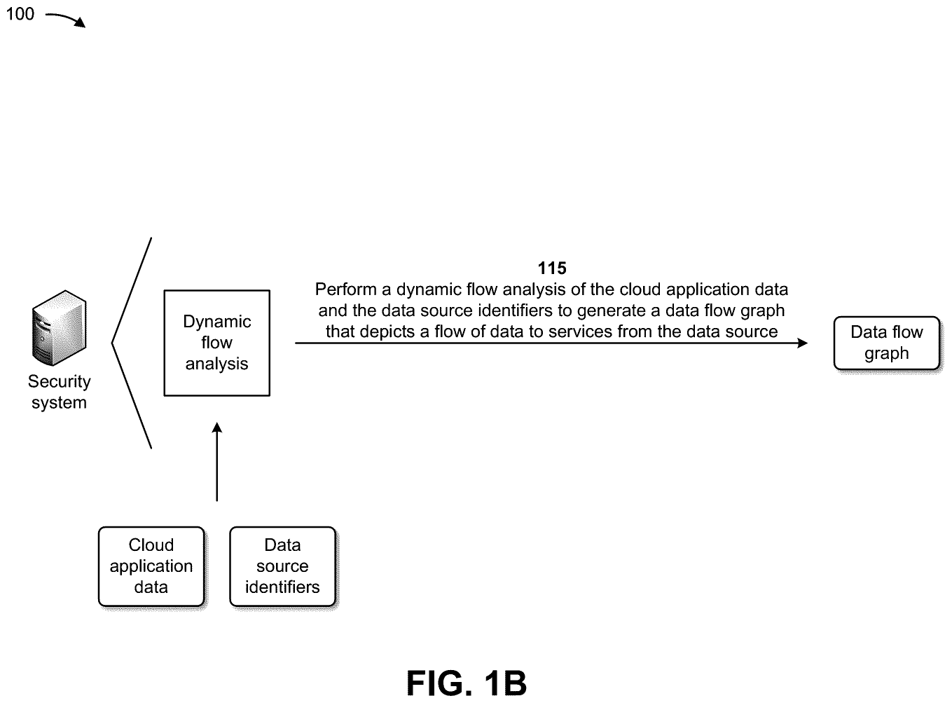

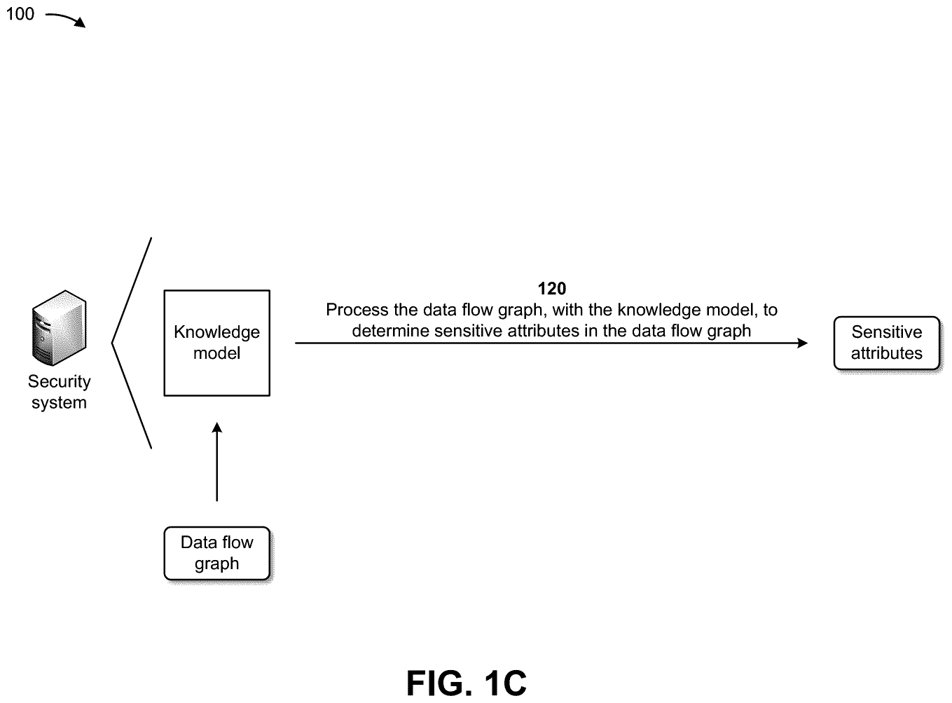

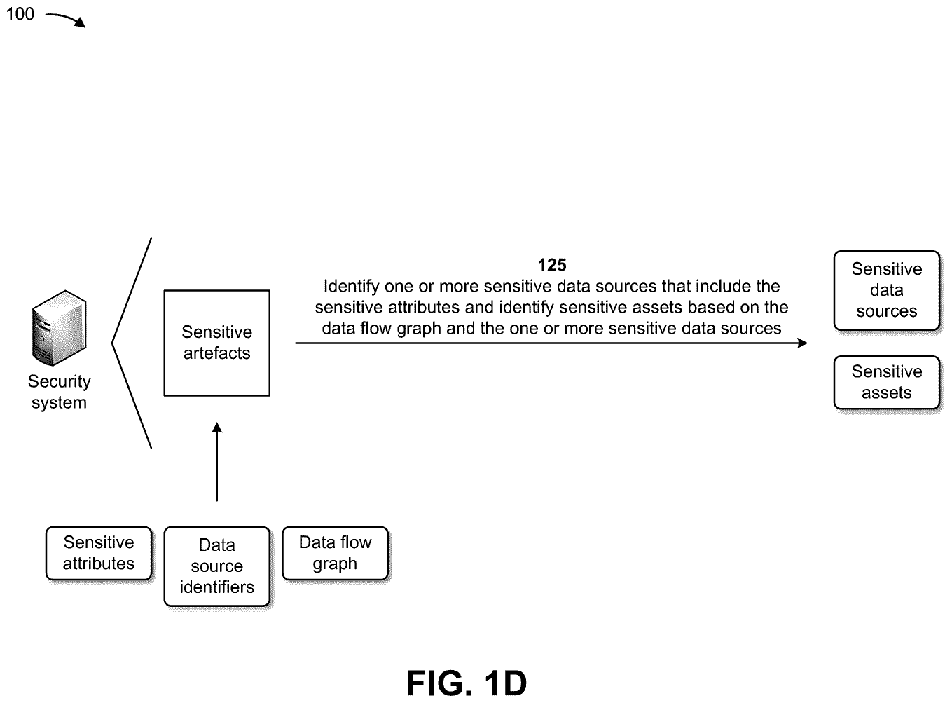

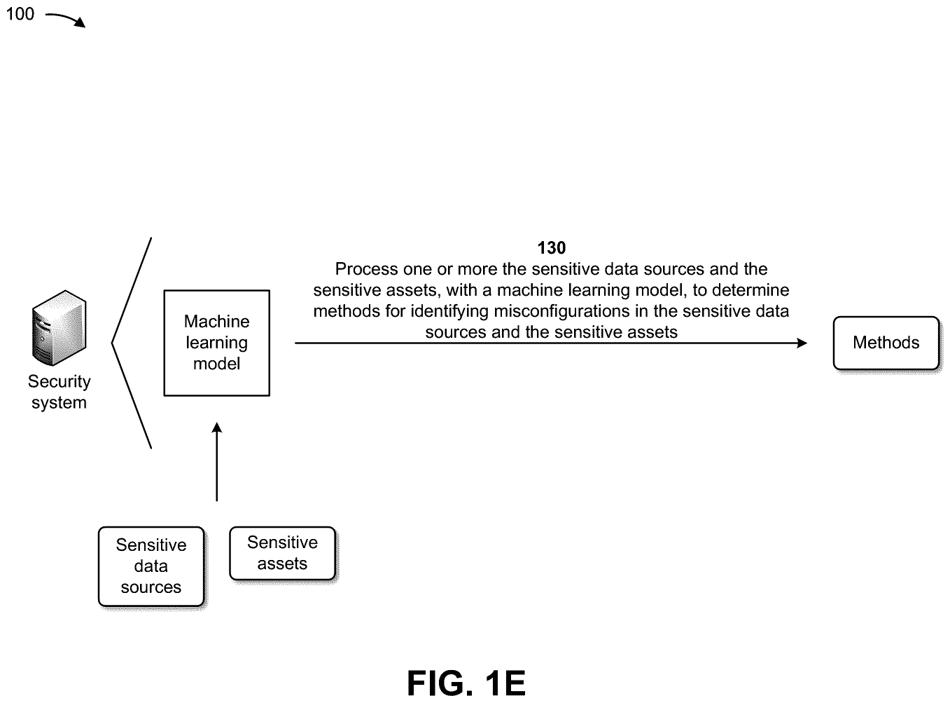

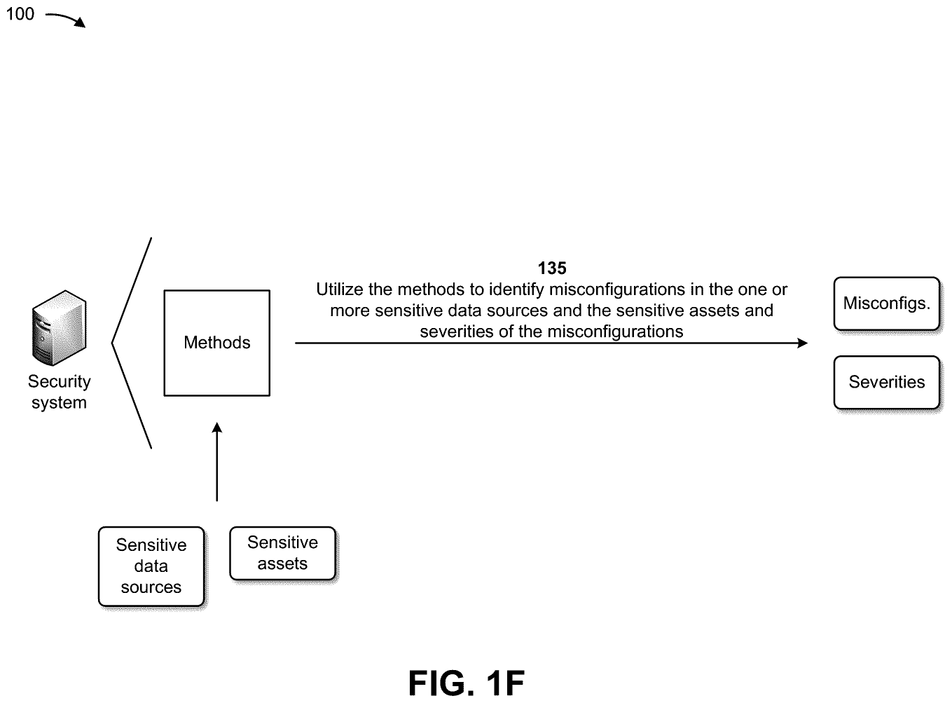

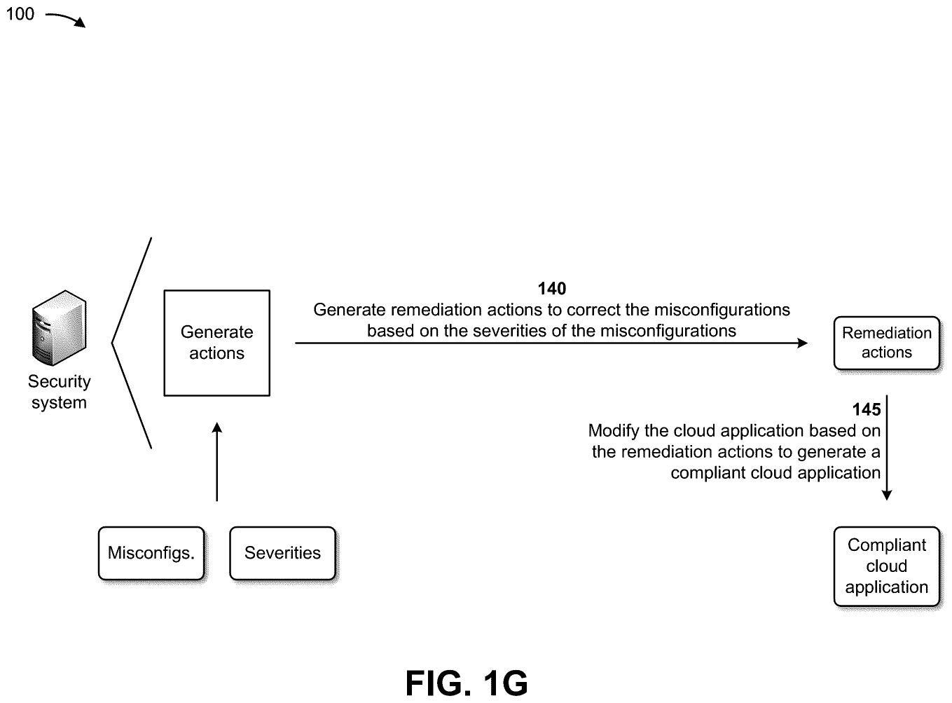

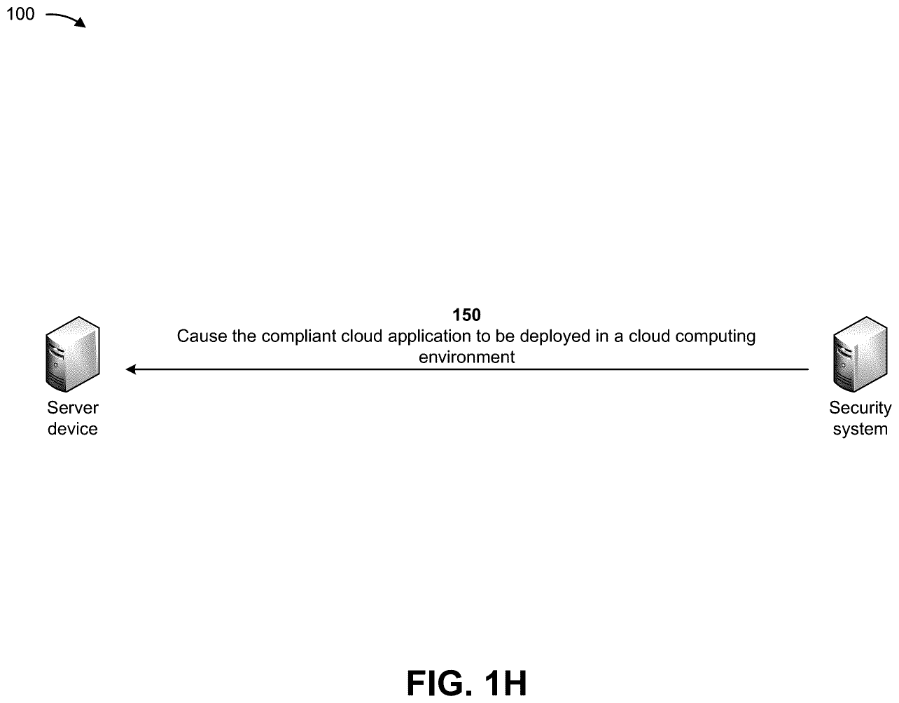

FIGS. 1A-1H are diagrams of an example 100 associated with discovering, assessing, and remediating cloud native application risks due to security misconfigurations. As shown in FIGS. 1A-1H, example 100 includes a security system associated with a server device. The security system may include a system that discovers, assesses, and remediates cloud native application risks due to security misconfigurations. Further details of the security system and the server device are provided elsewhere herein.

As shown in FIG. 1A, and by reference number 105, the security system may receive cloud application data associated with a cloud application, data source identifiers, knowledge model schema, data residency constraints, and a data classification ontology. For example, a user (e.g., a developer) may create a cloud application to be deployed in a cloud computing environment, and may wish to determine whether the cloud application includes any security issues. Alternatively, the cloud application may be deployed in the cloud computing environment (e.g., in the server device), and may require a security evaluation. In some implementations, the server device may provide the cloud application data to the security system (e.g., prior to being deployed in the cloud computing environment), and the security system may receive the cloud application data from the server device. Alternatively, when the cloud application is deployed in the cloud computing environment, the security system may request and receive the cloud application data from the server device in order to perform a security evaluation of the cloud application. In some implementations, the cloud application data includes data identifying an architecture flow of the cloud application, a process flow of the cloud application, a control flow of the cloud application, interconnections between microservices and data sources of the cloud application, and/or the like.

The server device may also provide the data source identifiers, the knowledge model schema, the data residency constraints, and the data classification ontology to the security system and the security system may receive the data source identifiers, the knowledge model schema, the data residency constraints, and the data classification ontology from the server device or another device, such as user device associated with a subject matter expert. The data source identifiers may include details of data stored in data sources (e.g., repositories) of the cloud application. The knowledge model schema may be provided by a subject matter expert and may include a structure that reflects content of the knowledge model. The data residency constraints may include categories of data identified based on data characteristics, industry domain, and security constraints, and may be utilized for identifying information as confidential or private in a data source. The data classification ontology may be defined by a subject matter expert and may include an ontology of associated confidential or private data fields for security practices.

As further shown in FIG. 1A, and by reference number 110, the security system may generate a knowledge model based on the knowledge model schema, the data residency constraints, and the data classification ontology. For example, the security system may instantiate a knowledge model by defining data sovereignty security practices around personal data based on applicability of the data security practices. The security system may utilize the knowledge model schema to generate a structure for the knowledge model. The security system may then populate the structure of the knowledge model with the data residency constraints, such as the categories of data identified based on data characteristics, industry domain, and security constraints. The security system may populate the structure of the knowledge model with the data classification ontology, such as the ontology of associated confidential or private data fields for security practices. In some implementations, the security system may store custom methods for governing microservice configurations in the knowledge model, and may utilize the custom methods to identify security misconfigurations. The security system may generate the knowledge model based on a prospective architecture of the cloud application (e.g., an architecture flow, a process flow, a control flow, and/or the like) that depicts interconnections of microservices and resource/data units, and based on data stored in various repositories.

As further shown in FIG. 1A, an example knowledge model may include invalid source nodes (e.g., a regulatory path node, a non-regulatory containers node, and a non-regulatory volumes node) with invalid edges, and valid source nodes (e.g., a non-regulatory volumes node, three regulatory containers nodes, a regulatory namespace node, a regulatory volumes node, and a regulatory path node) with valid edges.

As shown in FIG. 1B, and by reference number 115, the security system may perform a dynamic flow analysis of the cloud application data and the data source identifiers to generate a data flow graph that depicts a flow of data to services from a data source. For example, when performing the dynamic flow analysis of the cloud application data and the data source identifiers to generate the data flow graph, the security system may perform a dynamic analysis of a flow of data through application programming interfaces (APIs), database connection points, and calls (e.g., hypertext transfer protocol (HTTP) calls) to other services by the cloud application to generate the data flow graph. In some implementations, the data flow graph may depict a flow of data to services from a particular data source (e.g., identified by the data source identifiers). A data flow graph is a graph that represents a data dependencies between a number of operations. A data flow may represent a flow of data through a process or a system, and may provide information about outputs and inputs of each entity and the process itself. The data flow graph may include a collection of arcs and nodes, in which the nodes are either places where variables are assigned or used, and the arcs show a relationship between the places where a variable is assigned and where the assigned value is subsequently used.

As shown in FIG. 1C, and by reference number 120, the security system may process the data flow graph, with the knowledge model, to determine sensitive attributes in the data flow graph. For example, for each data source identified by the data source identifiers, the security system may utilize the knowledge model to identify sensitive attributes in the data flow graph, and may label each identified data source to include sensitive information. In some implementations, the knowledge model may compare the flow of data to services from each identified data source with the data residency constraints and the data classification ontology to determine the sensitive attributes in the flow of data. In such implementations, the combination of the sensitive attributes in the flows of data to services in the identified data sources may correspond to the sensitive attributes in the data flow graph.

As shown in FIG. 1D, and by reference number 125, the security system may identify one or more sensitive data sources that include the sensitive attributes and may identify sensitive assets based on the data flow graph and the one or more sensitive data sources. For example, as described above, the security system may utilize the knowledge model to identify the sensitive attributes associated with one or more identified data sources, and may label each of the one or more identified data sources to as one or more sensitive data sources associated with the cloud application. The security system may then utilize the one or more sensitive data sources and the data flow graph to identify the sensitive assets of the cloud application. In some implementations, when identifying the sensitive assets based on the data flow graph and the one or more sensitive data sources, the security system may identify sensitive assets of one or more microservices of the cloud application that handle sensitive information.

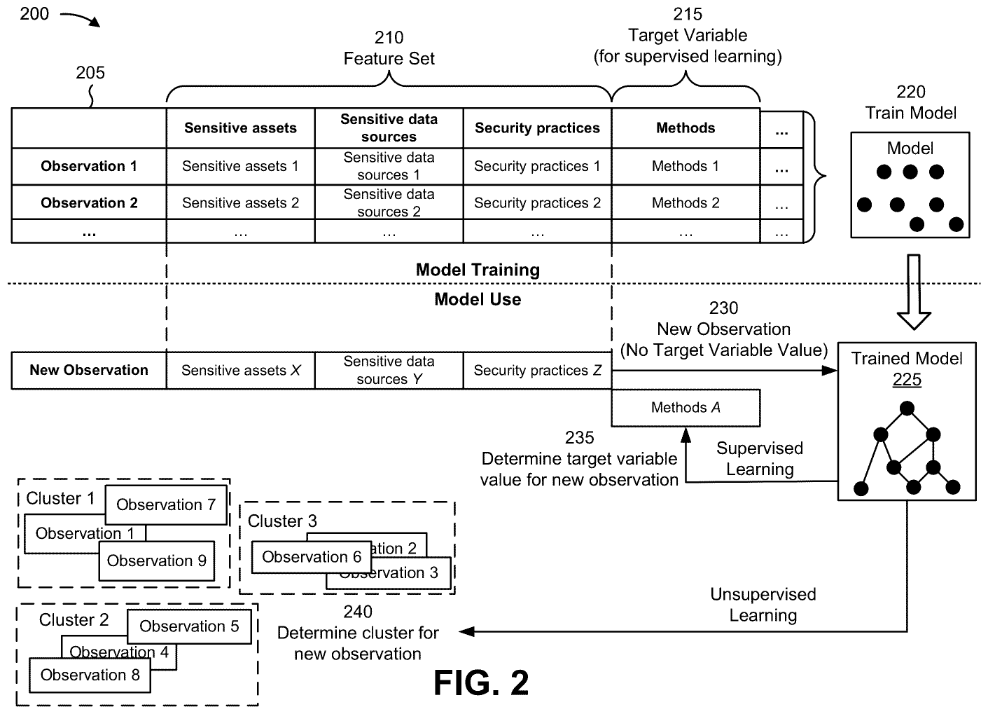

As shown in FIG. 1E, and by reference number 130, the security system may process the one or more sensitive data sources and the sensitive assets, with a machine learning model, to determine methods for identifying misconfigurations in the sensitive data sources and the sensitive assets. For example, the security system may be associated with a machine learning model, such as a pattern matching model, that is configured to determine methods for identifying misconfigurations in the sensitive data sources and the sensitive assets. Further details of training and utilizing the machine learning model are described below in connection with FIG. 2. In some implementations, when processing the one or more sensitive data sources and the sensitive assets, with the machine learning model, to determine the methods, the security system may process the one or more sensitive data sources, the sensitive assets, and security practices, with the machine learning model, to determine the methods for identifying misconfigurations in the sensitive data sources and the sensitive assets and/or and points of conflict (e.g., sensitive assets causing vulnerabilities). In some implementations, the methods may include a sensitive namespace and container method, a non-sensitive container running as a root, an ingress and egress network method, a protecting sensitive volume method, and/or the like.

As shown in FIG. 1F, and by reference number 135, the security system may utilize the methods to identify misconfigurations in the one or more sensitive data sources and the sensitive assets and severities of the misconfigurations. For example, the security system may implement the methods determined by the machine learning model to identify the misconfigurations in the one or more sensitive data sources and the sensitive assets and the severities of the misconfigurations. In some implementations, when utilizing the methods to identify the misconfigurations in the one or more sensitive data sources and the sensitive assets and the severities of the misconfigurations, the security system may generate an incident bipartite graph based on the methods, the sensitive assets, and the one or more sensitive data sources. The incident bipartite graph may include a vertex representing the one or more sensitive data sources, the sensitive assets, and the methods and may include edges representing interconnections and applicability for the one or more sensitive data sources and the sensitive assets. The incident bipartite graph may depict faulty configurations in the one or more sensitive data sources and the sensitive assets. Thus, the security system may identify the misconfigurations in the one or more sensitive data sources and the sensitive assets and the severities of the misconfigurations based on the incident bipartite graph.

As shown in FIG. 1G, and by reference number 140, the security system may generate remediation actions to correct the misconfigurations based on the severities of the misconfigurations. For example, the security system may determine optimal compliant configuration changes (e.g., remediation actions) to correct each of the misconfigurations in the one or more sensitive data sources and the sensitive assets based on the severities of the misconfigurations. In some implementations, when generating the remediation actions to correct the misconfigurations, the security system may group the misconfigurations based on occurrence of a particular sensitive asset (e.g., based on the severity associated with the sensitive asset). The security system may generate potential remediation actions based on grouping the misconfigurations, and may identify, as the remediation actions, a subset of the potential remediation actions based on least number of modifications required to correct the misconfigurations. In some implementations, the security system may utilize the potential remediation actions to reconfigure connections between the edges and the vertex of the incident bipartite graph, and may iterate the potential remediation actions over the incident bipartite graph until there are no disjoint or independent sets of misconfigurations remaining in the incident bipartite graph.

As further shown in FIG. 1G, and by reference number 145, the security system may modify the cloud application based on the remediation actions to generate a compliant cloud application. For example, the security system may execute the remediation actions to correct each of the misconfigurations in the one or more sensitive data sources and the sensitive assets of the cloud application. In some implementations, when modifying the cloud application based on the remediation actions to generate the compliant cloud application, the security system may incorporate the remediation actions in the cloud application to reconfigure the cloud application and generate the compliant cloud application.

As shown in FIG. 1H, and by reference number 150, the security system may cause the compliant cloud application to be deployed in a cloud computing environment. For example, if the server device is a resource of a cloud computing environment, the security system may provide the compliant cloud application to the server device, and the server device may deploy the compliant cloud application in the cloud computing environment. In some implementations, the security system may provide the compliant cloud application to the cloud computing environment, and the cloud computing environment may deploy the compliant cloud application in a container of the cloud computing environment.

In some implementations, the security system may provide a strategy recommendation for mitigating vulnerabilities (e.g., misconfigurations) associated with the cloud application, and may determine optimal and/or minimal quantities of changes required to mitigate the vulnerabilities. The security system may utilize continuous integration and continuous deployment (CI/CD) pipeline tools to enable real time modification for easy vulnerability remediation.

In some implementations, the security system may utilize a sensitive namespace (e.g., a namespace that logically isolates sensitive and non-sensitive resources) and container method that prevents a non-sensitive container from residing in a sensitive namespace since a non-sensitive container associated with a sensitive namespace may access all sensitive containers (e.g., containers associated with highly sensitive data and that operate as a controller or a processor). The security system may prevent a non-sensitive container from executing as a root since a non-sensitive container executing as a root may access sensitive containers. The security system may define ingress and egress network constraints for sensitive containers and an ingress Internet protocol (IP)-block range in a Kubernetes configuration file. This may prevent other containers from also accessing the sensitive containers. The security system may protect sensitive volumes (e.g., volumes that store sensitive data or personal identifiable information (PII) data) by preventing, in a configuration file, a non-sensitive container from accessing a sensitive volume and by preventing all non-sensitive containers from mounting to a sensitive path (e.g., a directory location where all sensitive volumes are mounted).

In this way, the security system discovers, assesses, and remediates cloud native application risks due to security misconfigurations. The security system may secure configuration files (e.g., of a cloud native application) for security vulnerabilities, compliance issues, and infrastructure misconfigurations, and may label artifacts with sensitive information in a microservice application architecture for pre-deployment compliance assessment and automatic remediation for noncompliance. The security system may generate target deployment configurations (e.g., for the cloud native application) that are compliant and secure in terms of data sensitivity, client inputs, and applicable constraints. This, in turn, conserves computing resources, networking resources, and/or the like that would otherwise have been consumed in failing to accurately assess whether the application can be viably migrated to a cloud computing environment, spending time and money and other resources on migration of a non-functional application to the cloud computing environment, attempting and failing to migrate the application to the cloud computing environment, and/or the like.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

FIG. 2 is a diagram illustrating an example 200 of training and using a machine learning model in connection with discovering, assessing, and remediating cloud native application risks due to security misconfigurations. The machine learning model training and usage described herein may be performed using a machine learning system. The machine learning system may include or may be included in a computing device, a server, a cloud computing environment, or the like, such as the security system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the security system, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the security system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of sensitive assets, a second feature of sensitive data sources, a third feature of security practices, and so on. As shown, for a first observation, the first feature may have a value of sensitive assets 1, the second feature may have a value of sensitive data sources 1, the third feature may have a value of security practices 1, and so on. These features and feature values are provided as examples, and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is methods, which has a value of methods 1 for the first observation. The feature set and target variable described above are provided as examples, and other examples may differ from what is described above.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of sensitive assets X, a second feature of sensitive data sources Y, a third feature of security practices Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of methods A for the target variable of methods for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a sensitive assets cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a sensitive data sources cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified. The recommendations, actions, and clusters described above are provided as examples, and other examples may differ from what is described above.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model).

In this way, the machine learning system may apply a rigorous and automated process to discover, assess, and remediate cloud native application risks due to security misconfigurations. The machine learning system may enable recognition and/or identification of tens, hundreds, thousands, or millions of features and/or feature values for tens, hundreds, thousands, or millions of observations, thereby increasing accuracy and consistency and reducing delay associated with discovering, assessing, and remediating cloud native application risks due to security misconfigurations relative to requiring computing resources to be allocated for tens, hundreds, or thousands of operators to manually discover, assess, and remediate cloud native application risks due to security misconfigurations using the features or feature values.

As indicated above, FIG. 2 is provided as an example. Other examples may differ from what is described in connection with FIG. 2.

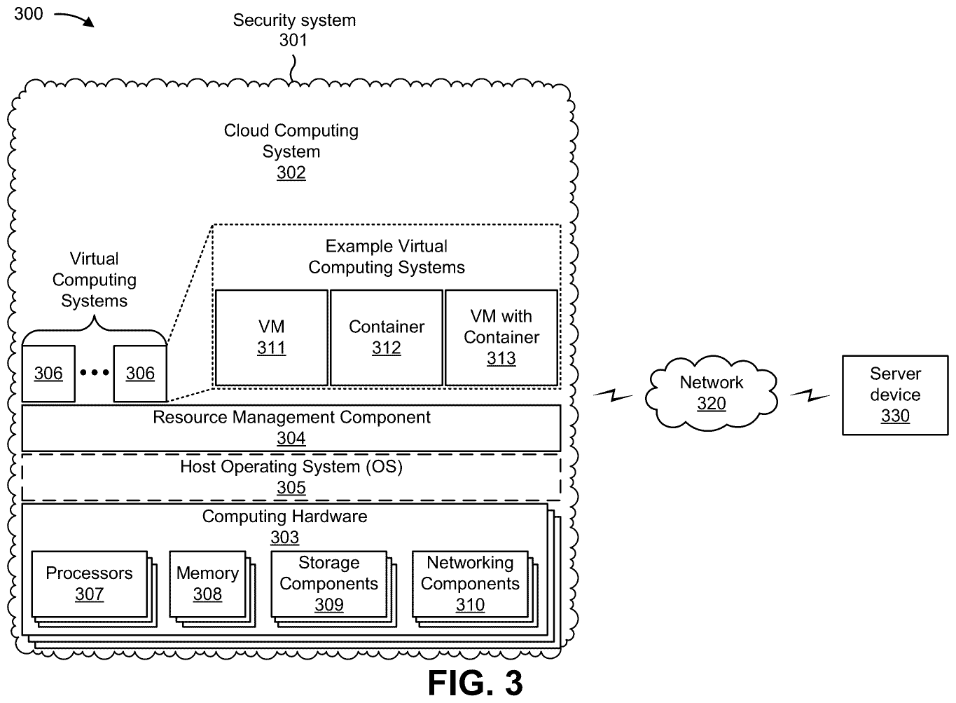

FIG. 3 is a diagram of an example environment 300 in which systems and/or methods described herein may be implemented. As shown in FIG. 3, the environment 300 may include a security system 301, which may include one or more elements of and/or may execute within a cloud computing system 302. The cloud computing system 302 may include one or more elements 303-313, as described in more detail below. As further shown in FIG. 3, the environment 300 may include a network 320 and/or a server device 330. Devices and/or elements of the environment 300 may interconnect via wired connections and/or wireless connections.

The cloud computing system 302 includes computing hardware 303, a resource management component 304, a host operating system (OS) 305, and/or one or more virtual computing systems 306. The resource management component 304 may perform virtualization (e.g., abstraction) of the computing hardware 303 to create the one or more virtual computing systems 306. Using virtualization, the resource management component 304 enables a single computing device (e.g., a computer, a server, and/or the like) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing the computing hardware 303 to start, stop, and/or manage the one or more virtual computing systems 306. For example, the resource management component 304 may include a hypervisor (e.g., a bare-metal or Type 1 hypervisor, a hosted or Type 2 hypervisor, and/or the like) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 311, a container 312, a hybrid environment 313 that includes a virtual machine and a container, and/or the like. A virtual computing system 306 may execute one or more applications using a file system that includes binary files, software libraries, and/or other resources required to execute applications on a guest operating system (e.g., within the virtual computing system 306) or the host operating system 305.

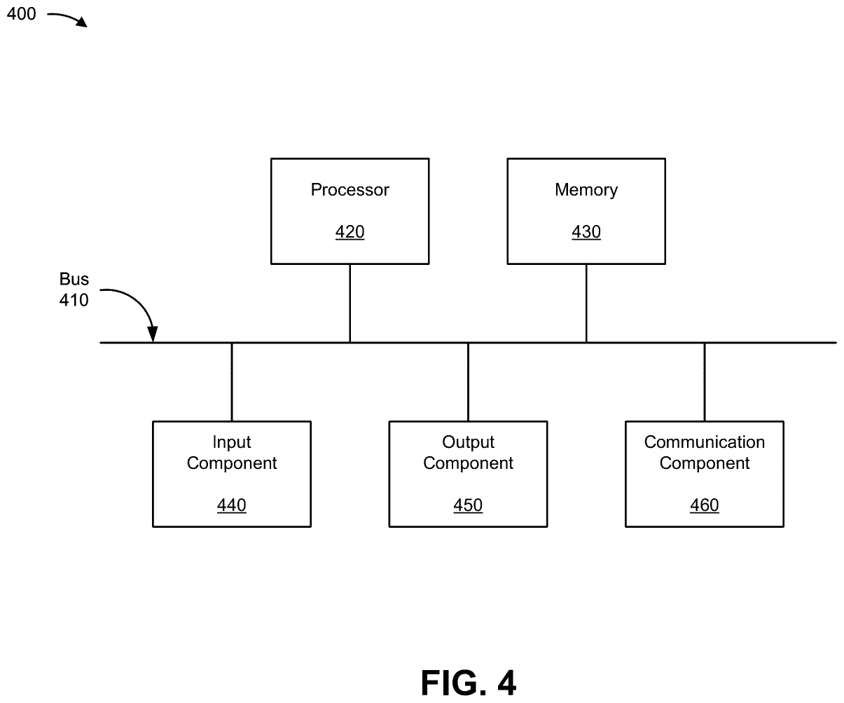

Although the security system 301 may include one or more elements 303-313 of the cloud computing system 302, may execute within the cloud computing system 302, and/or may be hosted within the cloud computing system 302, in some implementations, the security system 301 may not be cloud-based (e.g., may be implemented outside of a cloud computing system) or may be partially cloud-based. For example, the security system 301 may include one or more devices that are not part of the cloud computing system 302, such as device 400 of FIG. 4, which may include a standalone server or another type of computing device. The security system 301 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or the like, and/or a combination of these or other types of networks. The network 320 enables communication among the devices of the environment 300.

The server device 330 may include one or more devices capable of receiving, generating, storing, processing, providing, and/or routing information, as described elsewhere herein. The server device 330 may include a communication device and/or a computing device. For example, the server device 330 may include a server, such as an application server, a client server, a web server, a database server, a host server, a proxy server, a virtual server (e.g., executing on computing hardware), or a server in a cloud computing system. In some implementations, the server device 330 may include computing hardware used in a cloud computing environment.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the security system 301 and/or the server device 330. In some implementations, the security system 301 and/or the server device 330 may include one or more devices 400 and/or one or more components of the device 400. As shown in FIG. 4, the device 400 may include a bus 410, a processor 420, a memory 430, an input component 440, an output component 450, and a communication component 460.

The bus 410 includes a component that enables wired and/or wireless communication among the components of device 400. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform a function. The memory 430 includes a random-access memory, a read only memory, and/or another type of memory (e.g., a flash memory, a magnetic memory, and/or an optical memory).

The input component 440 enables the device 400 to receive input, such as user input and/or sensed inputs. For example, the input component 440 may include a touch screen, a keyboard, a keypad, a mouse, a button, a microphone, a switch, a sensor, a global positioning system component, an accelerometer, a gyroscope, an actuator, and/or the like. The output component 450 enables the device 400 to provide output, such as via a display, a speaker, and/or one or more light-emitting diodes. The communication component 460 enables the device 400 to communicate with other devices, such as via a wired connection and/or a wireless connection. For example, the communication component 460 may include a receiver, a transmitter, a transceiver, a modem, a network interface card, an antenna, and/or the like.

The device 400 may perform one or more processes described herein. For example, a non-transitory computer-readable medium (e.g., the memory 430) may store a set of instructions (e.g., one or more instructions, code, software code, program code, and/or the like) for execution by the processor 420. The processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

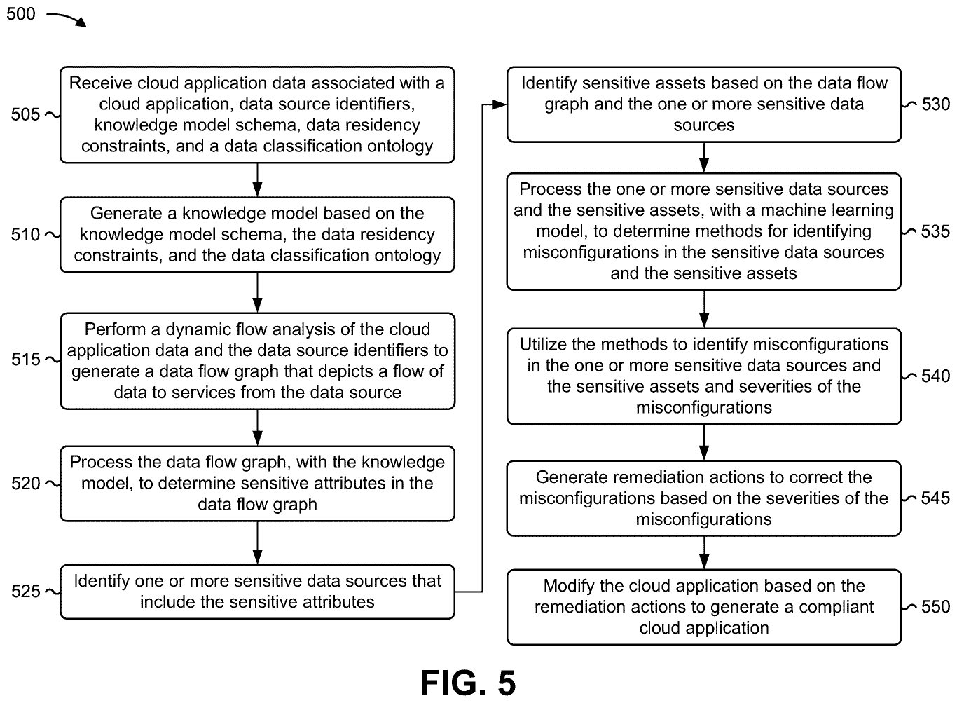

FIG. 5 is a flowchart of an example process 500 for discovering, assessing, and remediating cloud native application risks due to security misconfigurations. In some implementations, one or more process blocks of FIG. 5 may be performed by a device (e.g., the security system 301). In some implementations, one or more process blocks of FIG. 5 may be performed by another device or a group of devices separate from or including the device, such as a server device (e.g., the server device 330). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving cloud application data associated with a cloud application, data source identifiers, knowledge model schema, data residency constraints, and a data classification ontology (block 505). For example, the device may receive cloud application data associated with a cloud application, data source identifiers, knowledge model schema, data residency constraints, and a data classification ontology, as described above. In some implementations, the cloud application data includes data identifying an architecture flow of the cloud application, a process flow of the cloud application, and a control flow of the cloud application. In some implementations, the data source identifiers include details of data stored in repositories of the cloud application. In some implementations, the data residency constraints include categories of data identified based on data characteristics, industry domain, and security constraints to be utilized for identifying information as confidential or private in a data source. In some implementations, the data classification ontology includes an ontology of associated confidential or private data fields for security practices.

As further shown in FIG. 5, process 500 may include generating a knowledge model based on the knowledge model schema, the data residency constraints, and the data classification ontology (block 510). For example, the device may generate a knowledge model based on the knowledge model schema, the data residency constraints, and the data classification ontology, as described above.

As further shown in FIG. 5, process 500 may include performing a dynamic flow analysis of the cloud application data and the data source identifiers to generate a data flow graph that depicts a flow of data to services from the data source (block 515). For example, the device may perform a dynamic flow analysis of the cloud application data and the data source identifiers to generate a data flow graph that depicts a flow of data to services from the data source, as described above. In some implementations, performing the dynamic flow analysis of the cloud application data and the data source identifiers to generate the data flow graph includes performing a dynamic analysis of a flow of data through application programming interfaces, database connection points, and calls to other services by the cloud application to generate the data flow graph.

As further shown in FIG. 5, process 500 may include processing the data flow graph, with the knowledge model, to determine sensitive attributes in the data flow graph (block 520). For example, the device may process the data flow graph, with the knowledge model, to determine sensitive attributes in the data flow graph, as described above.

As further shown in FIG. 5, process 500 may include identifying one or more sensitive data sources that include the sensitive attributes (block 525). For example, the device may identify one or more sensitive data sources that include the sensitive attributes, as described above.

As further shown in FIG. 5, process 500 may include identifying sensitive assets based on the data flow graph and the one or more sensitive data sources (block 530). For example, the device may identify sensitive assets based on the data flow graph and the one or more sensitive data sources, as described above. In some implementations, identifying the sensitive assets based on the data flow graph and the one or more sensitive data sources includes identifying the sensitive assets of a microservice of the cloud application that handles sensitive information.

As further shown in FIG. 5, process 500 may include processing the one or more sensitive data sources and the sensitive assets, with a machine learning model, to determine methods for identifying misconfigurations in the sensitive data sources and the sensitive assets (block 535). For example, the device may process the one or more sensitive data sources and the sensitive assets, with a machine learning model, to determine methods for identifying misconfigurations in the sensitive data sources and the sensitive assets, as described above. In some implementations, processing the one or more sensitive data sources and the sensitive assets, with the machine learning model, to determine the methods includes processing the one or more sensitive data sources, the sensitive assets, and security practices, with the machine learning model, to determine the methods. In some implementations, the machine learning model is a pattern matching model.

As further shown in FIG. 5, process 500 may include utilizing the methods to identify misconfigurations in the one or more sensitive data sources and the sensitive assets and severities of the misconfigurations (block 540). For example, the device may utilize the methods to identify misconfigurations in the one or more sensitive data sources and the sensitive assets and severities of the misconfigurations, as described above. In some implementations, utilizing the methods to identify the misconfigurations in the one or more sensitive data sources and the sensitive assets and the severities of the misconfigurations includes generating an incident bipartite graph based on the methods, the sensitive assets, and the one or more sensitive data sources, and identifying the misconfigurations in the one or more sensitive data sources and the sensitive assets and the severities of the misconfigurations based on the incident bipartite graph.

As further shown in FIG. 5, process 500 may include generating remediation actions to correct the misconfigurations based on the severities of the misconfigurations (block 545). For example, the device may generate remediation actions to correct the misconfigurations based on the severities of the misconfigurations, as described above. In some implementations, generating the remediation actions to correct the misconfigurations includes grouping the misconfigurations based on occurrence of a particular sensitive asset, generating potential remediation actions based on grouping the misconfigurations, and identifying, as the remediation actions, a subset of the potential remediation actions based on least number of modifications required to correct the misconfigurations.

As further shown in FIG. 5, process 500 may include modifying the cloud application based on the remediation actions to generate a compliant cloud application (block 550). For example, the device may modify the cloud application based on the remediation actions to generate a compliant cloud application, as described above. In some implementations, modifying the cloud application based on the remediation actions to generate the compliant cloud application includes incorporating the remediation actions in the cloud application to reconfigure the cloud application and generate the compliant cloud application.

In some implementations, process 500 includes causing the compliant cloud application to be deployed in a cloud computing environment.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, and/or the like, depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, cloud application data associated with a cloud application, data source identifiers, knowledge model schema, data residency constraints, and a data classification ontology;
generating, by the device, a knowledge model based on the knowledge model schema, the data residency constraints, and the data classification ontology;
performing, by the device, a dynamic flow analysis of the cloud application data and the data source identifiers to generate a data flow graph that depicts a flow of data to services from the data source;
processing, by the device, the data flow graph, with the knowledge model, to determine sensitive attributes in the data flow graph;
identifying, by the device, one or more sensitive data sources that include the sensitive attributes;
identifying, by the device, sensitive assets based on the data flow graph and the one or more sensitive data sources;
processing, by the device, the one or more sensitive data sources and the sensitive assets, with a machine learning model, to determine methods for identifying misconfigurations in the sensitive data sources and the sensitive assets;
utilizing, by the device, the methods to identify misconfigurations in the one or more sensitive data sources and the sensitive assets and severities of the misconfigurations;
generating, by the device, remediation actions to correct the misconfigurations based on the severities of the misconfigurations; and
modifying, by the device, the cloud application based on the remediation actions to generate a compliant cloud application.

2. The method of claim 1, further comprising:
causing the compliant cloud application to be deployed in a cloud computing environment.

3. The method of claim 1, wherein the cloud application data includes data identifying an architecture flow of the cloud application, a process flow of the cloud application, and a control flow of the cloud application.

4. The method of claim 1, wherein the data source identifiers include details of data stored in repositories of the cloud application.

5. The method of claim 1, wherein the data residency constraints include categories of data identified based on data characteristics, industry domain, and security constraints to be utilized for identifying information as confidential or private in a data source.

6. The method of claim 1, wherein the data classification ontology includes an ontology of associated confidential or private data fields for security practices.

7. The method of claim 1, wherein performing the dynamic flow analysis of the cloud application data and the data source identifiers to generate the data flow graph comprises:
performing a dynamic analysis of a flow of data through application programming interfaces, database connection points, and calls to other services by the cloud application to generate the data flow graph.

8. A device, comprising:
one or more memories; and
one or more processors, coupled to the one or more memories, configured to:
receive cloud application data associated with a cloud application, data source identifiers, knowledge model schema, data residency constraints, and a data classification ontology;
generate a knowledge model based on the knowledge model schema, the data residency constraints, and the data classification ontology;
perform a dynamic flow analysis of the cloud application data and the data source identifiers to generate a data flow graph that depicts a flow of data to services from the data source;
process the data flow graph, with the knowledge model, to determine sensitive attributes in the data flow graph;
identify one or more sensitive data sources that include the sensitive attributes;
identify sensitive assets based on the data flow graph and the one or more sensitive data sources;
process the one or more sensitive data sources and the sensitive assets, with a machine learning model, to determine methods for identifying misconfigurations in the sensitive data sources and the sensitive assets;
utilize the methods to identify misconfigurations in the one or more sensitive data sources and the sensitive assets and severities of the misconfigurations;
generate remediation actions to correct the misconfigurations based on the severities of the misconfigurations;
modify the cloud application based on the remediation actions to generate a compliant cloud application; and
cause the compliant cloud application to be deployed in a cloud computing environment.

9. The device of claim 8, wherein the one or more processors, to identify the sensitive assets based on the data flow graph and the one or more sensitive data sources, are configured to:
identify the sensitive assets of a microservice of the cloud application that handles sensitive information.

10. The device of claim 8, wherein the one or more processors, to process the one or more sensitive data sources and the sensitive assets, with the machine learning model, to determine the methods, are configured to:
process the one or more sensitive data sources, the sensitive assets and security practices, with the machine learning model, to determine the methods.

11. The device of claim 8, wherein the machine learning model is a pattern matching model.

12. The device of claim 8, wherein the one or more processors, to utilize the methods to identify the misconfigurations in the one or more sensitive data sources and the sensitive assets and the severities of the misconfigurations, are configured to:
generate an incident bipartite graph based on the methods, the sensitive assets, and the one or more sensitive data sources; and
identify the misconfigurations in the one or more sensitive data sources and the sensitive assets and the severities of the misconfigurations based on the incident bipartite graph.

13. The device of claim 8, wherein the one or more processors, to generate the remediation actions to correct the misconfigurations, are configured to:
group the misconfigurations based on occurrence of a particular sensitive asset;
generate potential remediation actions based on grouping the misconfigurations; and
identify, as the remediation actions, a subset of the potential remediation actions based on least number of modifications required to correct the misconfigurations.

14. The device of claim 8, wherein the one or more processors, to modify the cloud application based on the remediation actions to generate the compliant cloud application, are configured to:
incorporate the remediation actions in the cloud application to reconfigure the cloud application and generate the compliant cloud application.

15. A non-transitory computer-readable medium storing a set of instructions, the set of instructions comprising:
one or more instructions that, when executed by one or more processors of a device, cause the device to:
receive cloud application data associated with a cloud application, data source identifiers, knowledge model schema, data residency constraints, and a data classification ontology,
wherein the cloud application data includes data identifying an architecture flow of the cloud application, a process flow of the cloud application, and a control flow of the cloud application;
generate a knowledge model based on the knowledge model schema, the data residency constraints, and the data classification ontology;
perform a dynamic flow analysis of the cloud application data and the data source identifiers to generate a data flow graph that depicts a flow of data to services from the data source;
process the data flow graph, with the knowledge model, to determine sensitive attributes in the data flow graph;
identify one or more sensitive data sources that include the sensitive attributes;
identify sensitive assets based on the data flow graph and the one or more sensitive data sources;
process the one or more sensitive data sources and the sensitive assets, with a machine learning model, to determine methods for identifying misconfigurations in the sensitive data sources and the sensitive assets;
utilize the methods to identify misconfigurations in the one or more sensitive data sources and the sensitive assets and severities of the misconfigurations;
generate remediation actions to correct the misconfigurations based on the severities of the misconfigurations; and
modify the cloud application based on the remediation actions to generate a compliant cloud application.

16. The non-transitory computer-readable medium of claim 15, wherein the one or more instructions further cause the device to:
cause the compliant cloud application to be deployed in a cloud computing environment.

17. The non-transitory computer-readable medium of claim 15, wherein the one or more instructions, that cause the device to perform the dynamic flow analysis of the cloud application data and the data source identifiers to generate the data flow graph, cause the device to:
perform a dynamic analysis of a flow of data through application programming interfaces, database connection points, and calls to other services by the cloud application to generate the data flow graph.

18. The non-transitory computer-readable medium of claim 15, wherein the one or more instructions, that cause the device to process the one or more sensitive data sources and the sensitive assets, with the machine learning model, to determine the methods, cause the device to:
process the one or more sensitive data sources, the sensitive assets and security practices, with the machine learning model, to determine the methods.

19. The non-transitory computer-readable medium of claim 15, wherein the one or more instructions, that cause the device to utilize the methods to identify the misconfigurations in the one or more sensitive data sources and the sensitive assets and the severities of the misconfigurations, cause the device to:
generate an incident bipartite graph based on the methods, the sensitive assets, and the one or more sensitive data sources; and
identify the misconfigurations in the one or more sensitive data sources and the sensitive assets and the severities of the misconfigurations based on the incident bipartite graph.

20. The non-transitory computer-readable medium of claim 15, wherein the one or more instructions, that cause the device to generate the remediation actions to correct the misconfigurations, cause the device to:
group the misconfigurations based on occurrence of a particular sensitive asset;
generate potential remediation actions based on grouping the misconfigurations; and
identify, as the remediation actions, a subset of the potential remediation actions based on least number of modifications required to correct the misconfigurations.
